(19) United States
(12) Patent Application Publication
(10) Pub. No.: US 2008/0282949 A1
(43) Pub. Date: Nov. 20, 2008

(54) Equipment for Seedlings Plantation With Simultaneous Application of Moisturizing Products Based on Water, Soil Improvers and/or Fertilizers and the Corresponding System of Planting Seedlings

(75) Inventor: Omar El Jamal, Sao Paulo (BR)

Correspondence Address: BAKER & ASSOCIATES PLLC, 470 EAST NINTH AVENUE, SALT LAKE CITY, UT, 84103, US

(73) Assignee: Empresa de Base & distribuidora LTDA, Sao Paulo (BR)

(21) Appl. No.: 11/997,295

(22) PCT Filed: Aug. 1, 2005
(86) PCT No.: PCT/BR05/00155

§ 371 Date: Jan. 29, 2008

(51) Int. Cl. A01C 11/02

(52) U.S. Cl. 111/108; 111/106

(57) ABSTRACT

This Patent is characterized for being constituted by an equipment (I) application device available in a basic model and two constructive variations, a product (P) formed by a composition of nitrogen (N); Phosphorus (P205); Potassium (K20); Calcium (Ca); Magnesium (Mg); Sodium (Na); Copper (Cu); Manganese (Mn); Iron (Fe); Zinc (Zn); Boron (B); Cobalt (Co); Sulfur (S) in variable quantities; a Water Retention Capacity or WRC and a Capacity of Cationic Change or CTC, also variable, and finally, a system or another operational way, in an individual or collective way, of plantation of seedlings (S) and application of the product (P) developed from the use of a tanker provider with a compressor and to which different hoses would be able to be connected in function of the quantity of workers work.

### 1. INTRODUCTION

The present invention refers to an equipment developed to plant seedlings and the respective system of planting seedlings, both notoriously developed to facilitate and to make faster the work of plantation of those seedlings, offering total security and efficiency being emphasized that the equipment was created with a double purpose and function, that is to say, apart from doing the plantation of the seedling, to use and to add, in a simultaneous way, all the products that the seedling needs such as, moisturizing products based on water, improvers of ground, etc., configuring in this way, a system of plantation and the corresponding executing equipment of this plantation, which are elements of great utility, of easy handling according of its simplified structural characteristics, facilitating and becoming viable its industrial production, being emphasized that it is gifted of other technical characteristics that offer it an intrinsic news for the purpose it is made.

It is important to mention that the initial model is formed by a monoblock kind of equipment and of manual handling of plantation of seedlings, which includes a mechanical system to work and operate, both notoriously developed to facilitate and make faster the plantation execution service of those seedlings.

### 2 TECHNICAL BASEMENT

As it is of general knowledge among the professionals of the area just as agriculture engineers, technicians and others professional related to the cultivation of plants in general, the consumer market is supplied for some models of equipment especially created for the plantation of specific products, among which can be emphasized the shovels, hoes, large hoes, and other manual tools, widely used in the agriculture, especially in the plantation of seedlings.

The referred shovels, hoes and large hoes are used to make the plantation in a rudimental way and without any precision, apart from that, it is necessary to develop a great physical effort to open the trenches, to place, to tamp down and to plant those seedlings, being still necessary the application, and subsequently and of manual form, of the necessary products for the development and growth of the seedlings, things that demand a lot of time and low productivity with this method of plantation in function of the different necessary phases to complete the process of plantation, out of the need of an operative or of a professional highly qualified to carry out the referred plantation.

Other additional things coming from the use of this type of method for plantation of moult, are the different health problems as a result of the manual plantation that affect the professionals responsible for these tasks, because with the utilization of shovels, hoes and large hoes, all of them rudimentary devices, the professionals normally present muscular and spine problems

The traditional technique knows some models of automatic equipment for the plantation of seedlings that diminish or eliminate the physical efforts of those who work in the cultivation of nursery gardens and plants in general, having those equipments or tools attached to agricultural machines moved by traction, being emphasized those models that use compressed air and/or vacuum let the planting of seedlings in previously determined and planned spaces between the seedlings, having them planted in line and with conditions of dry or flooded soil. This system can be attached to a machine or to an adaptable machine to an agricultural tractor, being the configuration and dimension of this machine depending on the type of seedling that will be planted, of the conditions of the soil dry or flooded, and of the area to be worked on.

Another model of agricultural device by motor force drive, corresponds to a chassis fixed into the coupling of the tractor and provided of wheels with tires that resist and transmit movement to the system of plantation seen in the device; it has one or more elements of plantation, having each element constituted by a system to furrow and to normalize the land; a planting units system; an adjustable system of transmission of movement and a system of compressing around the seedlings. In this way, the device, after hooked and started the driving by a tractor, transmits, through the mounted wheels and of an adjustable system of gears and currents of transmission, the movement for the planting units system.

This system of plantation, at the same time, is formed by several planting units called of tongs, being emphasized that the moults are placed over the tongs and are immobilized when these get in contact with the plate of closing and development of the planting units. These plates were projected in a way to induce the movement of the tongs with the moults to the location and moment of the planting, when they are loosen and introduced into the soil, being compacted subsequently to the detachment of the seedlings.

Out of the rudimentary devices previously mentioned and of the heavy equipments, which are partially efficient, it cab be emphasized that the referred ones are of a very high cost, fact that makes difficult its acquisition by the majority of the producers/farmers. In the background of techniques basements there is a model formed by a planter aimed to the cultivation of plants in general, which is constituted by a dragging car gifted with a chassis in whose end it is arranged a system that permits to regulate the height in relation to the coupling devices of three points of the bucket, which holds the seat and the silo through columns, and also the axis of the wheel of support through the lateral supports, whose revolving movement is transmitted through serrated wheels, gears and chains covered by covers or protections, so that the synchronized device that holds and looses, totally adjustable, which is formed by a revolving disk that has an arm and counterweight, that places the nursery garden in the hole and completes with earth around it.

The device previously mentioned has a lower cost in comparison to the coupling devices to tractors in general, being formed by a complex structure and of difficult manipulation, being emphasized that the same one was developed barely and exclusively for the planting of seedlings.

The technical field of this Equipment corresponds to the agricultural area, forests and similar ones, intends to facilitate and to make faster the work of plantation of those seedlings, offering total security and efficiency being emphasized that the equipment was created with a double purpose and function, that is to say, apart from doing the plantation of the seedling, to use and to add, in a simultaneous way, all the products that the seedling needs such as, moisturizing products based on water, improvers of soil, etc., configuring in this way, a system of plantation and the corresponding executing equipment of this plantation, which are elements of great utility, of easy handling according of its simplified structural characteristics, facilitating and becoming viable its industrial production, being emphasized that it is gifted of other technical characteristics that offer it an intrinsic news for the purpose it is made.

### 3. BRIEF DESCRIPTION OF THE INVENTION

Analyzing the state of the technique and trying to provide better alternatives for the consumer market, the inventor developed the Equipment for Seedlings Plantation with Simultaneous Application of Moisturizing Products based on Water, Soil Improvers and/or Fertilizers and the Corresponding System of Planting Seedlings, the inventor developed an modular equipment for plantation of seedlings, which allows the simultaneous application of moisturizing products based on water, improvers of ground and/or fertilizers, the chemical composition or formulation of a moisturizing product based on water and finally, the system of application and operation.

3.1. The Equipment

The equipment, in any of the models presented, is manufactured preferably in metal, such as stainless steel or galvanized steel, aluminium or another adequate to its purposes and concerns about a mechanical device, constituted of a main cylindrical body, leaked and long, with a conical end, which is especially developed for the opening of pits for the plantation of seedlings, being therefore, gifted of an articulated movable part for the opening and passage of the seedlings and of the products for its full development.

Basic Model

This model is characterized for being constituted by a monoblock whole formed by a tubular cylindrical body, tip or conical end gifted with a movable part, gauntlets, means of operation, assembly of articulated transmission bars, tubular leaked and curved extension and a means of outflow, noticing that this model is a whole monoblock, that is to say, the main components perfectly fixed among them by means of weld or another means of permanent fixation, noticing that the same one is not provided with a head.

From the basic model and aiming at the different operational alternatives, as well as the different locations where the Equipment will be used, there were developed other models or constructive variations of the Equipment, as we have:

First Constructive Variation

In the development of this constructive variation it was used the concept of Modular Equipment or likely to be maintained in the locations where it is used, reason why the Equipment was divided into body, head, fixed and movable tip, tubular extension, means of outflow, means or devices of operation, articulated bars of transmission.

It may be noticed that all of the elements of this first constructive variation are noticeable and fixed by means of bolts with butterfly-like nuts, nuts or another means or element of fixation as paralock or a similar one, being that, only the tubular extension is permanently fixed to the fixed part of the tip.

Second Construction Variation

In the development of this constructive variation, were kept the same principles used in the First Variation with the difference that the articulated bars of transmission were replaced by flexible elements such as bicycles ends, ends of motorcycles or others adequate elements, all supplied with their mechanisms and elements of operation like springs, bars of fixation, etc.

Dose Device

Aiming at improving the operation of this Equipment even more and facing the different existing kinds of ground, the diverse cultures, whether of forest or agricultural order, it was developed a Dose Device of variable capacity, which will be able to be connected, optionally, to each one of the models, Basic, First or Second Constructive Variation.

3.2 The Chemical Composition

The Chemical Composition corresponds to a chemical fertilizer whose bigger quality is to be a fertilizer and a water container that, when incorporated upon the ground or substratum, it absorbs and keeps big quantities of water and of fertilizing elements, being that, to the contrary of the majority of the products that are moisturized, the Composition now in question, possesses the capacity of easily liberate the water and the nutrients for the plants or trees in function of the cycles absorption-liberation.

The Chemical Composition is presented in three different formulations or granulometries, with the purpose of offering different capacities of absorption and of liberation of water, being that and in a general way, the thinner the granulometry is, the bigger its capacity and its speed of absorption are.

The Chemical Composition, in any one of its formulations or granulometries is formed by Nitrogen (N); Phosphorus (P205); Potassium (K20); Calcium (Ca); Magnesium (Mg); Sodium (Na); Copper (Cu); Manganese (Mn); Iron (Fe); Zinc (Zn); Boron (B); Cobalt (Co); Sulfur (S); Aluminium (Al) and Molybdenum (Mo), noticing that all these elements are contained, accordingly to what was previously described, in variable quantities, showing a Capacity of Holding Water (WHC) and a Capacity of Change Cationic Change or CTC, also variable.

3.3. The Operating System

The Operating System allows to plant seedlings of a unique way, being that in this systematic operational, each worker carries in his back a rucksack or container with the Chemical Composition, noticing that, the second way to operate the System, is in a collective way, that is to say, in teams of work formed by four, five, six or more workers, all of them connected by hoses to a tanker, a towed tank or another means or equipment of storage and transport of big quantities of the Chemical Composition, this including a compressor, to supply an amount of fertilizer for all the members of the work team.

### 4. BACKGROUND OF THE INVENTION

Looking for the Background of the Invention, it was verified, by the survey performed together with the Brazilian Database of the National Institute of Industrial Property, that were found some Request of Privilege regarding some equipments, that can be used in agricultural and forest labor, as follows:

Patent, PI 8206164, filed on Oct. 22, 1982, titled “Manual Planting Tool of Seedlings” refers to a planting tool of seedlings of nursery, which consists of a metallic cylindrical pipe, supplied by a jaw in the lower part for the penetration in soil, being this, opened by means of a pedal so as to permit the operator to introduce the container with the seedlings in the muzzle to be placed inside the pit.

Patent, PI 8405123, filed on Oct. 5, 1984, titled “Manual Device For the Plantation of Seedlings, Seeds and Others”, notices an equipment of plantation characterized by permitting simultaneously the opening of the pit and the plantation of the moves in an only phase, resulting in quickness, working hand economy and efficiency. The device is manufactured from a pipe of PVC or another material and has a cone in his lower end, formed from two brims, that are nailed in soil and when open, by means of operation of an upper lever and another lower one, permit the passage and placed inside the pit of a small seedling that is introduced in the upper part of the pipe and that slides through it to get the mentioned pit.

Patent, PI 8602852, filed on Jun. 19, 1986, titled “Manual Planting Tool”, corresponds basically to a tubular cylindrical body, incorporated in its lower end a funnel projection of penetration in soil, through which seeds placed in the interior of the tubular body pass, these seeds being thrown outside through a pushing element set in the lower end of an longitudinal central axis moved axially pressing downward and upward of an end incorporated to its free top end.

Patent, MU 7601948-9 U, filed on Sep. 6, 1996, titled “Double Beak Fertilizer Planting/Distributor Tool”, notices an equipment endowed with double beak, that introduces into soil, simultaneously, the grains of seed and the necessary fertilizer to the development of the plant, un steady and precise way, facilitating the work of the farmer user, noticing that the same one is constituted by two holding arms, each one with a gauntlet, a box to contain the seeds, a transversally fixed bar, on one side, the arm and on the other, a bolt that collects and distributes the seeds to its leading pipe that, by its time, drives them to the double beak, which will be introduced into the soil. Furthermore, a fertilizer deposit box that in its interior has two small responsible bolts, respectively, by the opening and passage of the fertilizer through the opening and under its bottom part, another responsible bolt by the releasing of the fertilizer for its respective leading-pipe and, subsequently, to the double beak, and that is operated by another transversally fixed bar in one ends its own bolt and the arm in another, determining the course of this by the distance or approach of the arms of the fertilizer planting/distributor tool.

Patent, MU 7401671-7 U, filed on Sep. 14, 1994, titled “Improvements in Manual Planting Tool”, notices a plantation equipment-supplied by a double beak applying device, for the release of seeds and fertilizer separately, with triangular conical form composed by two beaks arranged side by side, fixed between them, however with different lengths, being the biggest beak for release of the fertilizer and the smaller beak for release of seeds, each beak is formed by two plates in form of spade, next to each other by a cross axis to simultaneously open and close the fixed beaks to the ends of the planting tool that through the manual movement, releases the fertilizer deeper than the seed under soil, without having any direct contact between them during the plantation, barely when in contact with the ground, not injuring the life of the seed.

Patent, PI 9701555-5 A, filed on Feb. 27, 1997, titled “Planting Tool of Smoke Seedlings”, notices an equipment of plantation characterized by consisting of a composed structure for two arms, articulated, endowed with gauntlets, guiding bars and, in the lower ends, of furrows, where it is located, between the same ones, a pipe, vertical, in slanted plane, properly fixed and supplied of a muzzle; being that, the located arm in the left side is endowed with base and space bar, supplied with tip.

Patent, MU 8201931-2 U, filed on Aug. 8, 2002, titled “Manual Planting Tool for Seedlings”, notices an equipment of plantation constituted by bars and doorknobs of metal, tube or pipe with pass of seedling, of PVC, or any other similar material, that has the functions of driving freely seedlings without making them suffer any damage caused by the path that takes the to be introduced into soil, through a beak of sharp metal with rounded form, to facilitate the task of the user in the introduction of the seedlings or seeds in lands of any feature, sandy, compact, etc.

### 5. TECHNICAL DIFFERENTIAL

The technical differential is based on the fact that the equipment permits to carry out three operations in once, in the first place, the opening of the hole, second, the planting of the different seedlings, one after the other, and the third operation, which consists of the application of the necessary products for the full development of these seedlings, such as, moisturized products or moisturizing based on water, soil improvers, fertilizers, etc., from the driving of the shaft that drives the spherical valve and of the opening device of the hole in the ground for the plantation of the seedling.

The equipment, in function of its physical configuration and simplified structure, permits any person to manipulate it in an efficient, secure, fast, and easy form, when planting seedlings, optimizing the time by the fact of doing the planting, and the application of the adequate products at the same time, providing the market consumer with an alternative of a very high productivity, low operational cost and an especially developed equipment for the simultaneous planting of seedlings and moisturizing products or soil improvers.

### 6. PROCESS OF PLANTATION

To plant a seedling it is necessary to continue the phases of operation described subsequently:
1—Introduction of the conical bottom end of the equipment in the ground, with both sections closed;
2—Introduction of the seedling in the equipment by the upper end of the same one;
3—Absorption of the fertilizing products, soil improvers or others in the deposit placed on the back of the operator;
4—Driving of the shaft of transmission that opens the spherical valve or registration to free the pass of the fertilizing products or others, and to drive simultaneously, the opening shaft of the sections, mobile and articulated, of the bottom end and that permits the pass of the seedling and of the fertilizing products or others and opening space in the ground to plant the seedling, and
5—Finally the equipment is withdrawn from the ground, covering the hole and concluding in this way, the plantation

### 7. BRIEF DESCRIPTION OF THE FIGURES

To complete the actual description as a way to obtain a perfect comprehension of the technical characteristics of the Equipment for Seedlings Plantation with Simultaneous Application of Moisturizing Products Based on Water, Soil Improvers and/or Fertilizers and the Corresponding System of Planting Seedlings, object of this Patent and according to a preferential practical execution of the same one, encloses, a group of drawings, where in an illustrated, but not limited way, was represented the following:

FIG. 1: Shows a frontal cut of the equipment for planting different seedlings.

FIG. 2: Shows a perspective view of the team being used by a producer.

FIG. 3 to 7: Show the operational sequence of the equipment during the planting of seedlings, that is to say, it shows frontal views of the equipment in the phase of introduction of the seedling, in the simultaneous application of the necessary products, in the opening of the hole and placement and release of the seedling in the ground and in the final phase with the withdrawn of the equipment and filling of the hole.

FIG. 8: Represents flow diagram of the Equipment for Seedlings Plantation with Simultaneous Application of Moisturizing Products based on Water, Soil Improvers and/or Fertilizers and the Respective System of Planting Seedlings.

FIG. 9: Corresponds to a perspective view of the first constructive variation.

FIG. 10: Shows a frontal view of the Equipment in its first constructive variation.

FIG. 11: Illustrates a side view of the Equipment in its first constructive variation.

FIG. 12: Represents a perspective view of the Equipment in its second constructive variation, this characterized by the use of flexible ends as elements of transmission instead of bars.

FIG. 13: Corresponds to a frontal view of the second constructive variation of the equipment.

FIG. 14: Shows a side view of the second constructive variation of the equipment.

FIG. 15: Illustrates a perspective view of the Dose Device.

FIG. 16: Represents an illustrative chart of the Chemical Composition named EB/HB 20.

FIG. 17: Corresponds to illustrative chart of the Chemical Composition named EB/HB 30.

FIG. 18: Refers to illustrative chart of the Chemical Composition named EB/HB 40.

FIG. 19: Shows operational flow diagram of the Collective Plantation System.

FIG. 20: Illustrates a perspective view of the Equipment in its constructive variation, supplied with the Dose Device.

FIG. 21: Represents a perspective view of the Equipment in its second constructive variation, provided with the Dose Device.

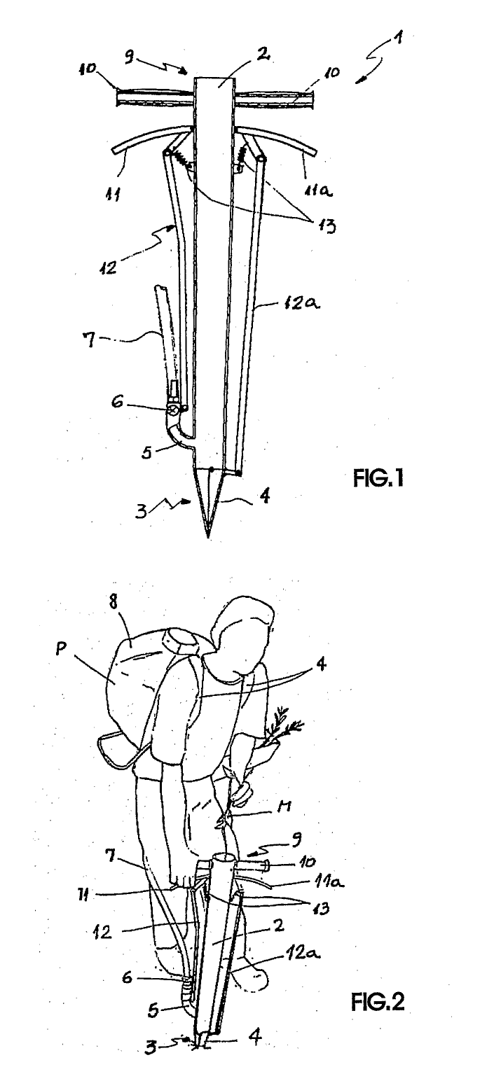

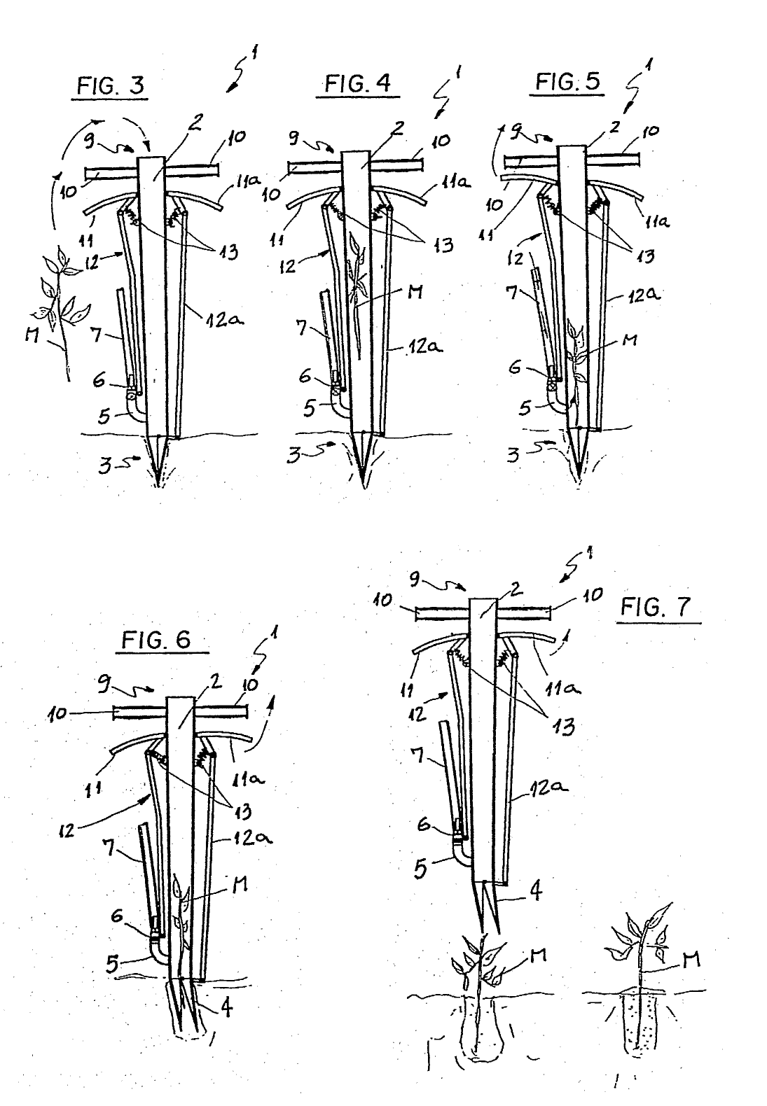

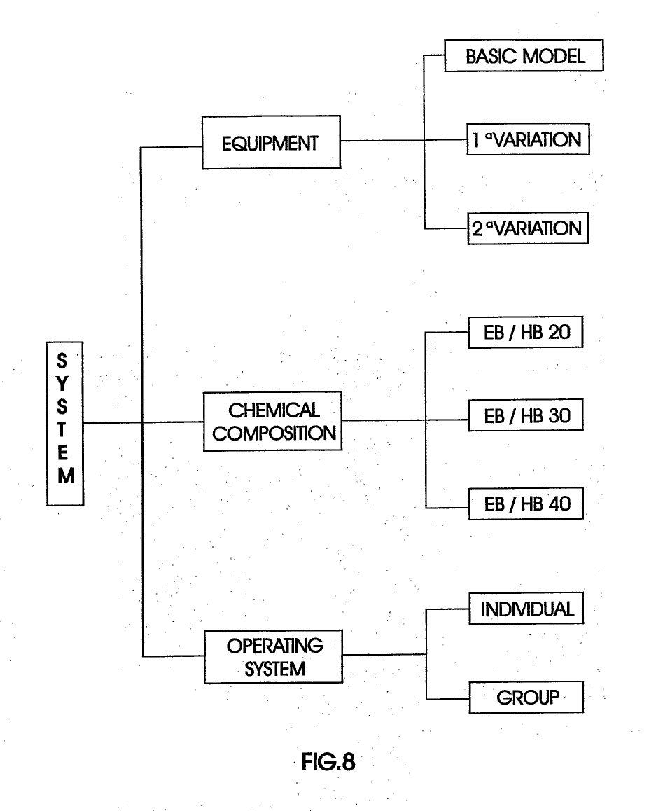

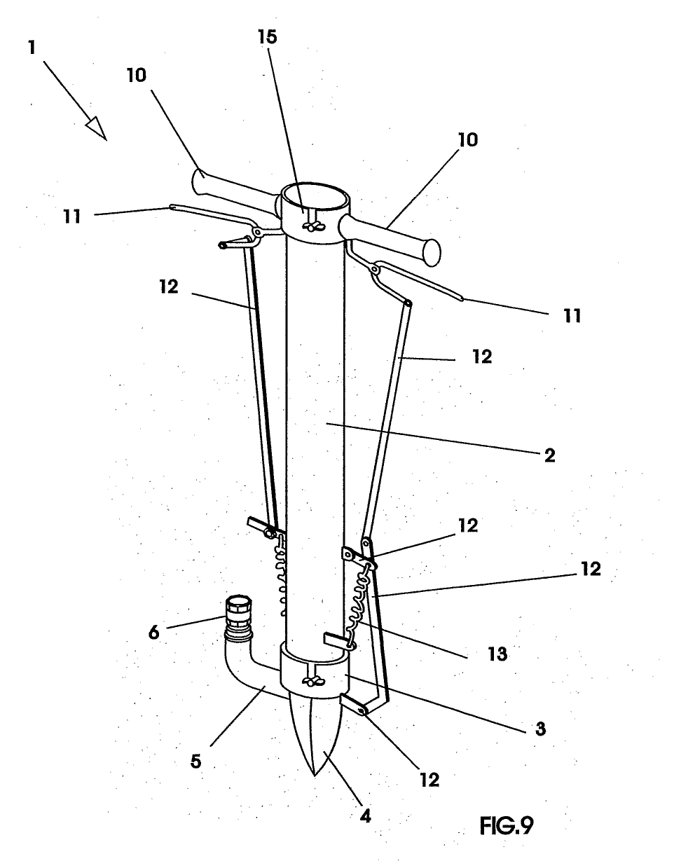

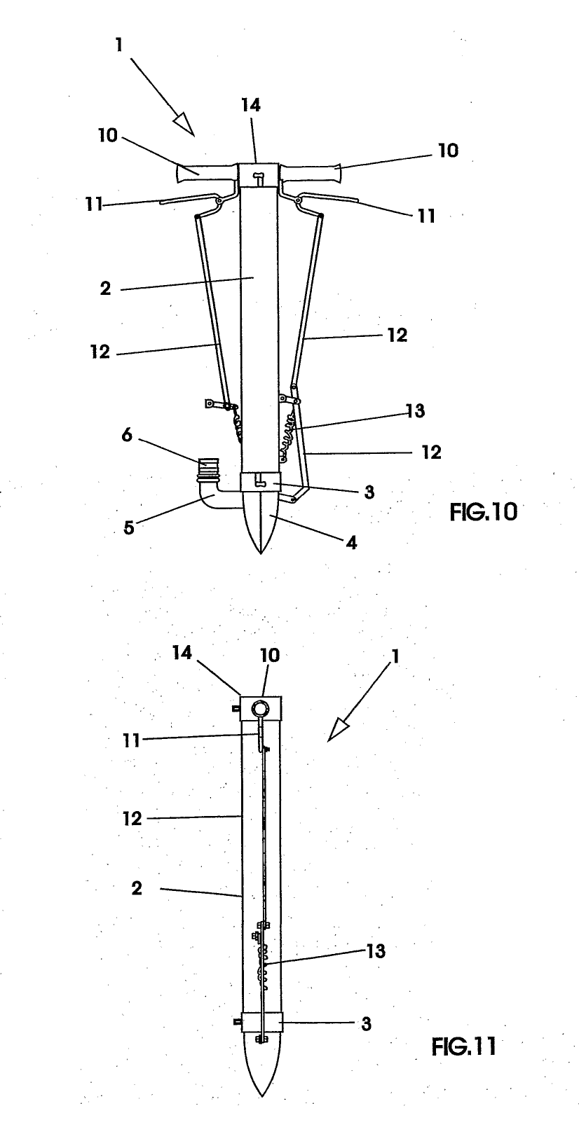

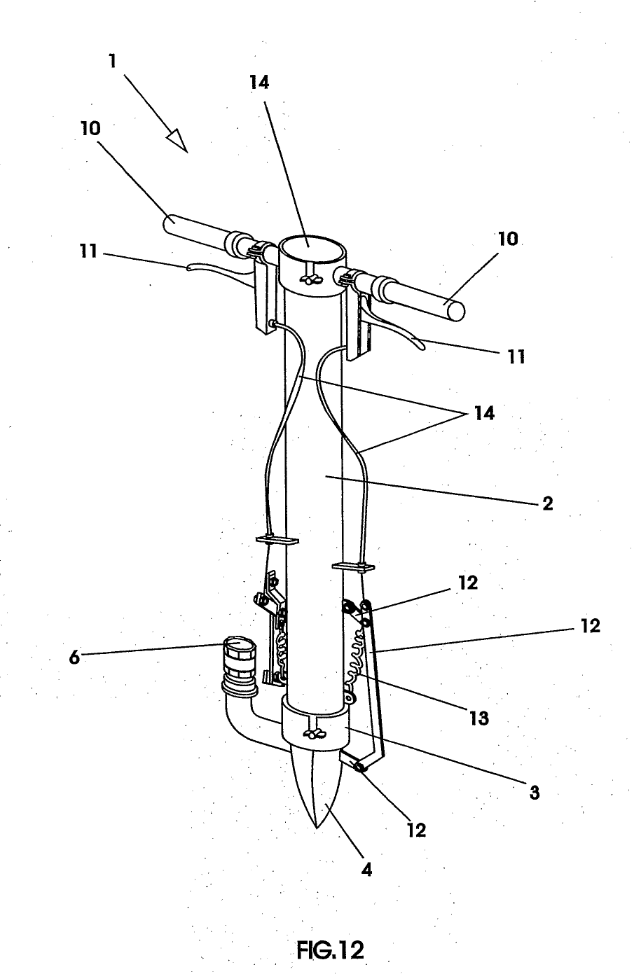

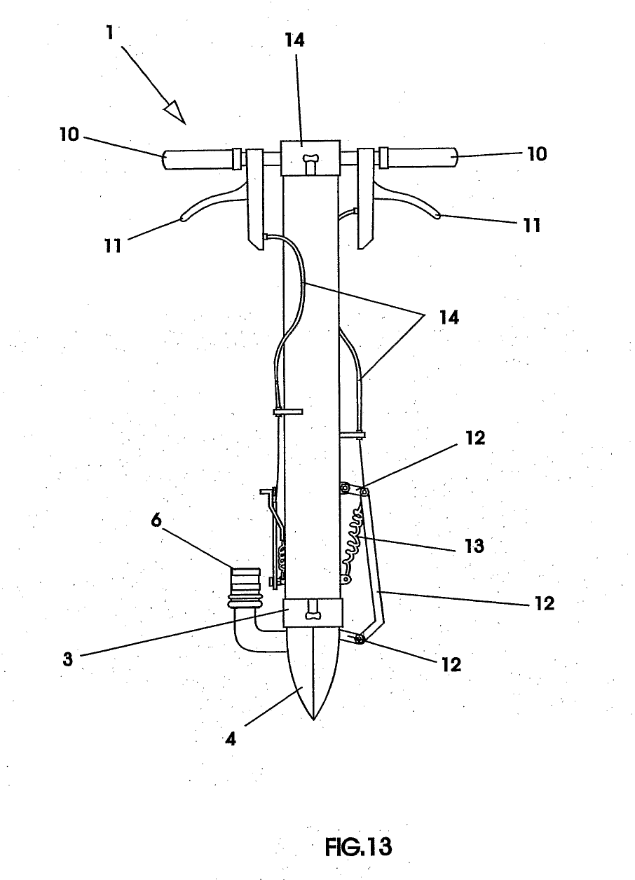

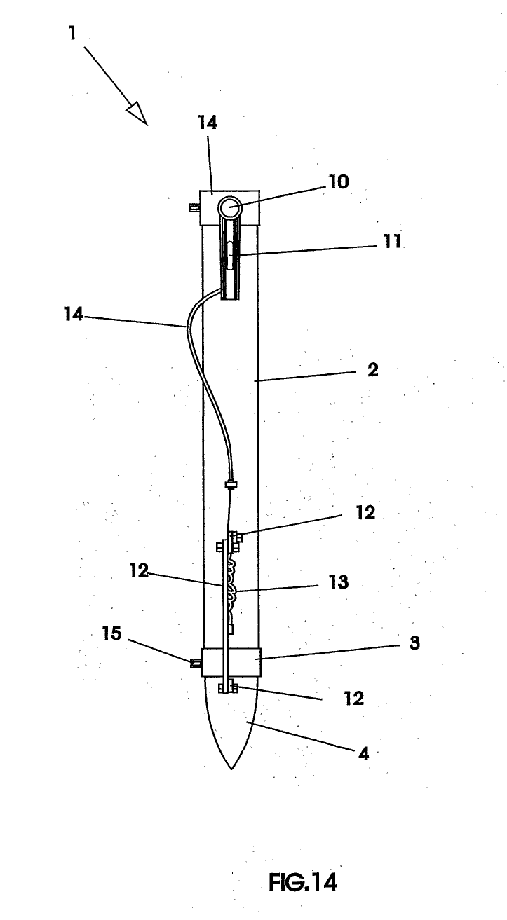

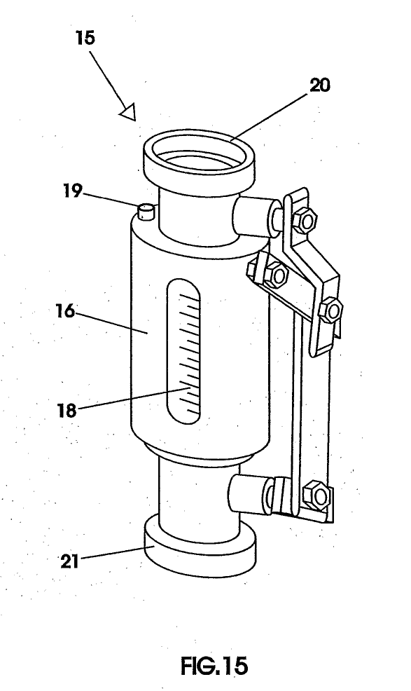

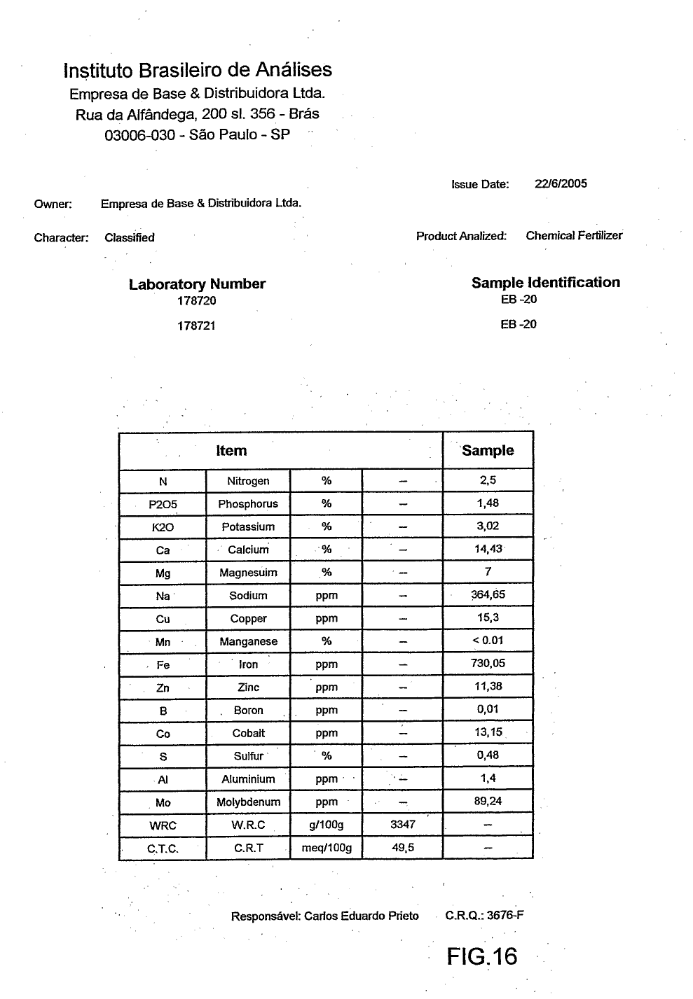

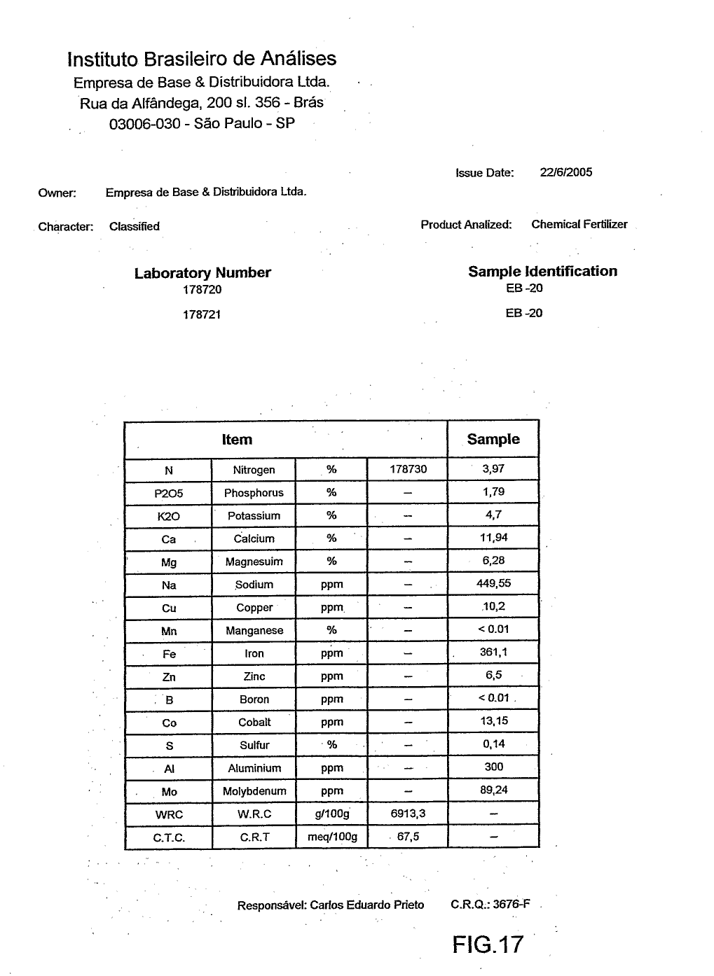

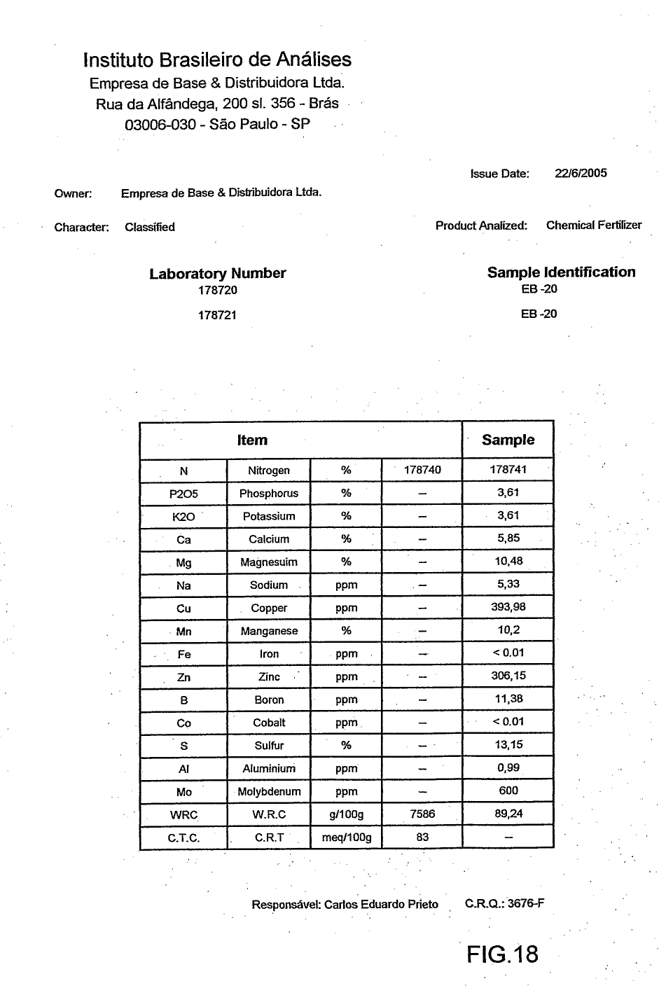

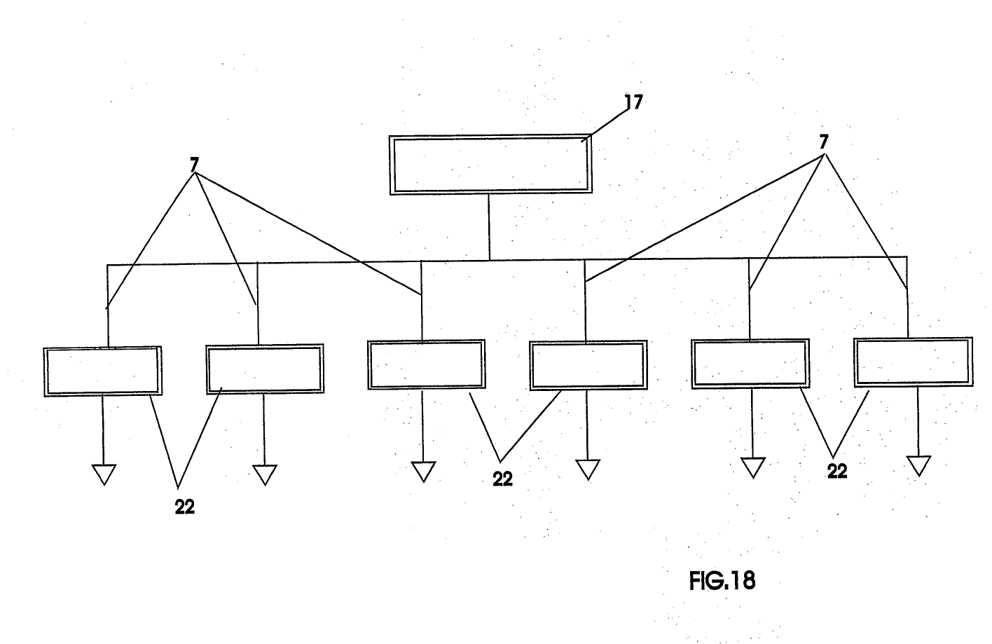

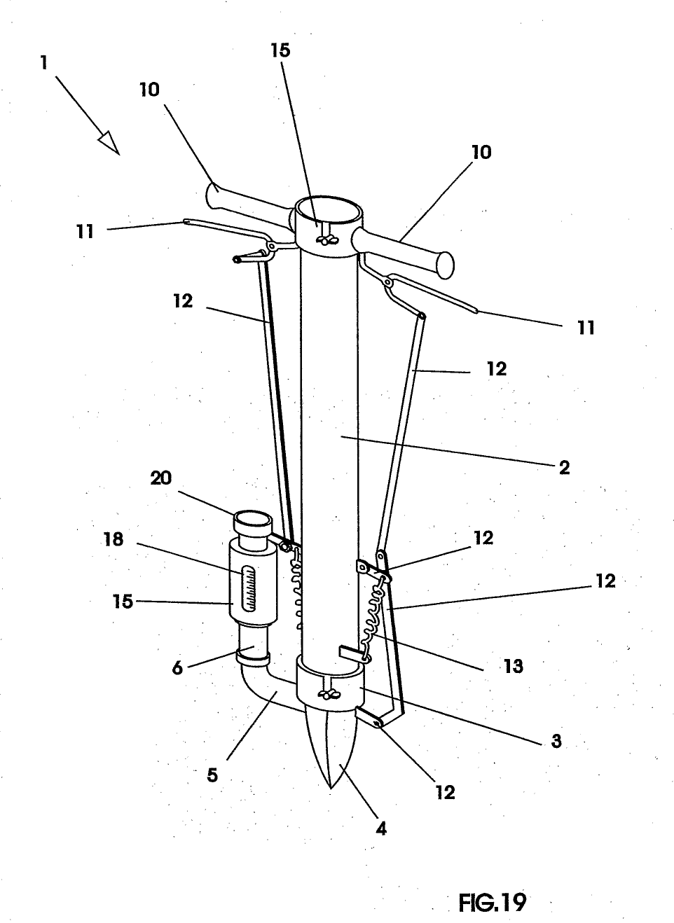

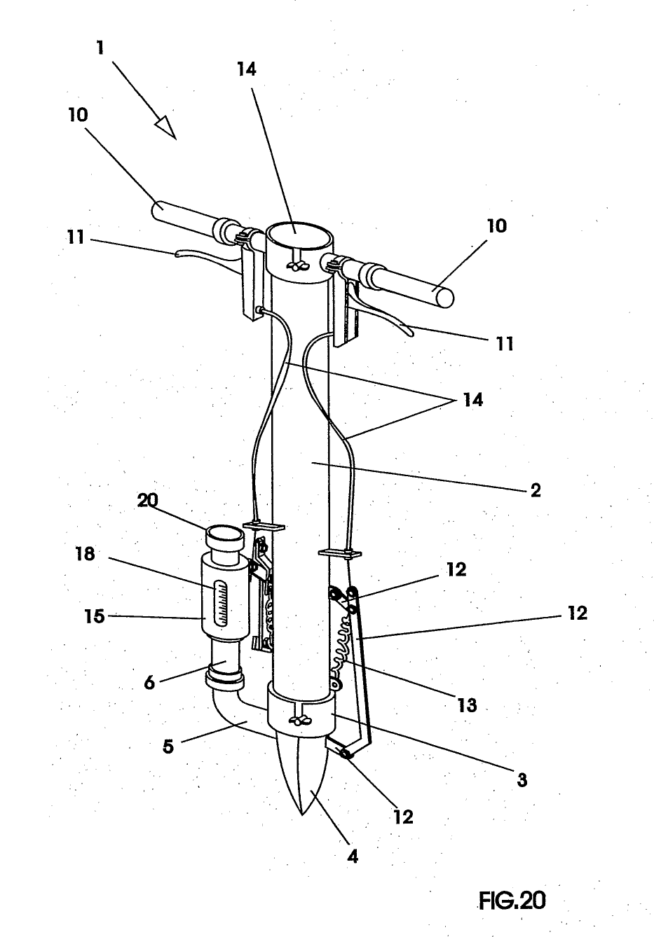

### 8. DETAILED DESCRIPTION OF THE INVENTION

As it is inferred from the designs, sheets of technical information, reports of physical analysis and technical card of the product, the Equipment for Seedlings Plantation with Simultaneous Application of Moisturizing Products Based on Water, Soil Improvers and/or Fertilizers and the Respective System of Planting Seedlings is characterized by being constituted by an equipment (1) applying device, a chemical composition improver of soil and absorbent of water to be applied by the equipment and a operational system, in an individual or group way, of plantation of seedlings (M) and application of the product (P).

8.1. The Equipment

The equipment (1), in any of the models presented, is manufactured preferably in metal, such as stainless steel or galvanized steel, aluminium or another adequate to its purposes and concerns about a mechanical device, constituted of a main cylindrical body, leaked and long, with a conical end, which is especially developed for the opening of pits for the plantation of seedlings, being therefore, gifted of an articulated movable part for the opening and passage of the seedlings and of the products for its full development.

First Construction Variation

This constructive variation uses the concept of Equipment (1) of the modular kind, foresees the maintenance in the localities of use, reason why the Equipment (1) was developed in unique components, fitted and able of be fixed among them by means of elements such as bolts, nuts and others, being in that way configured and divided in body (2), head (14), tip (3) with movable part (5), means of outflow (6), gauntlets (10), levers (11) or devices of operation, bars (12) of articulated transmission.

The body (2) is a tubular element of adequate diameter to allow the introduction and sliding of sheat dress containing seedlings (S) of different trees like pines, eucalyptus and others, being put and planted, one each time. In the upper end of the body (2) it was inserted and set by diverse means, the head (14), which corresponds to a ring of slightly bigger diameter regarding the body (2), it is provided with grooves, holes or openings to allow the placement of the devices of fixation (15), also provided with two gauntlets (10) perfectly welded or fixed by another means and protected by gauntlets of rubber or another. Immediately below the gauntlets the levers (11) or means of operation are arranged.

In the lower part of the body (2) the tip is located (3) gifted with its movable part (4), being that this tip (3) is formed by an upper ring that serves to fix the tip (3) to the body (2) by different devices of fixation.

It may be noticed that all of the elements of this first constructive variation are noticeable and inserted, fixed among them by different devices of fixation (15) such as bolts with butterflies, nuts or other means or elements of fixation like bolts, any kind of screw or similar ones, being that, only the tubular end is permanently fixed to the fixed part of the tip.

Second Constructive Variation

In the development of this constructive variation, were kept the same principles used in the First Variation with the difference that the articulated bars of transmission (12) were replaced by flexible elements such as ends (14), which could be from bicycles, ends of motorcycles or others adequate elements, all supplied with their mechanisms and elements of operation like springs, bars of fixation, etc.

Dose Device

Aiming at improving the operation of this Equipment (1) even more and facing the different existing kinds of ground, the diverse cultures, whether of forest or agricultural order, it was developed a Dose Device (14) of variable capacity, which will be able to be connected, optionally, to each one of the models, Basic, First or Second Constructive Variation.

This Dose Device (14) is a container (15) of tubular shape or another adequate one, with a variable capacity, 200 ml, 300 ml, 500 ml. or another one which will be determined according to the kind of soil of the region where the Equipment will be used.

Internally it is gifted with bezeled or chamfered walls, which have the purpose of facilitating the evacuation of the Product (P), even with the compressor of the tanker (16) functioning, due to the high viscosity of the Product (P), it also has a measurer (17) of volume, breath (18) or valve of relief or another means, valve of feeding (19), device of quick hitch (20) and levers of simultaneous operation (21).

8.2. The Chemical Composition

The Chemical Composition or product (P) is a combination of water and chemical fertilizer developed to be incorporated to the soil or substratum, it absorbs and keeps big quantities of water and of fertilizing elements, possessing the capacity of easily liberate the water and the nutrients for the plants in function of the cycles of absorption.

The Chemical Composition, here named EB-20; EB-30 and EB-40, that is to say, in any of its formulations or granulometries is formed by a percentage of nitrogen (N) between 2.50 and 3.97%; a percentage of Phosphorus (P) between 1.46 and 1.79%; a percentage of Potassium (K) between 3.02 and 5.85%; a percentage of Calcium (Ca) between 10.48 and 14.43%; a percentage of Magnesium (Mg) between 5.33 and 7.00%; a quantity of Sodium (Na) between 364.65 and 449.55 ppm; a quantity of Copper (Cu) between 10.20 and 15.30 ppm; a percentage of Manganese (Mn) lower to 0.01%; a quantity of Iron (Fe) between 306.15 and 730.05 ppm; a quantity of Zinc (Zn) variable between 6.50 and 11.38 ppm; a quantity of Boron (B) lower to 0.01 ppm; a quantity of Cobalt (Co) equivalent to 13.15 ppm; a percentage of Sulfur (S) between 0.14 and 0.99%; a quantity of Aluminium (Al) between 300 and 1400 ppm and a quantity of Molybdenum (Mo) equivalent to 89.24 ppm, noticing that all these elements are contained, according to what was previously described, in relation to the variables quantities of the kind of the chosen pro-duct (P), presenting a Water Retention Capacity or WRC between 3347 and 7586.00 g/100 g and a Capacity of Cationic Change or CTC between 49.50 and 83.00 meq/100 g.

It is important to notice that the percentages and quantities of elements contained in any of the formulations of the product (P) would be able to suffer modifications or alterations aiming at attending determined kinds of soils or cultures.

This hydro-container for soils and substratum shows among its real advantages, the capacity of increasing the useful backup of water in soils by several years, being that the frequency of irrigation can be limited until 50%; to limit the losses of water and of nutrients by dissolving; to reduce the evaporation of water of soil; to improve the physical states of the soils leaving them more aired and favouring the growth of the plants being that the nutrients are permanently available in the roots plant, improving the absorption by the plant.

Therefore, it is verified that the product is very efficient in the plantation of trees, bushes and seedlings (M), permitting to reduce the rate of mortality in the moment of the transplant and increasing the roots development.

Even more, in water seeding, this product can be used by hydraulic projection for the stabilization of just cut soils, being mixed or not with cellulose mulch.

Among other uses, it is important to stand out that for the protection of bare roots, in order to avoid the dryness of new seedlings (S), in the moment of the transplant or in the transport in long distances, it is convenient to mix 1.0 kg of the product in 150 to 200 litres of water, releasing it slowly into the water, leaving it waiting for 15 minutes, for that the polymer absorb the maximum one of water.

A second possibility of use, can be by mixing with substratum for cultures, guaranteeing a better fixation of the stakes and of seedlings (M) as well as a faster growth of the cultures just planted, being that the frequency of irrigation falls.

Another possibility is in the mixture with fertilizers, permitting and offering in the behaviour of the plants with that mixture, to increase the productivity preserving at the same time the environment.

In agriculture, this product (P) shows a real efficacy in its application in cultures mainly in the moment of the germination and of the development of the roots plant, due to the excellent aeration of the soil.

Finally, regard the technical facts of the product (P) and respective variations, the technical analyses enclosed in pictures 9 to 11 are presented, which correspond to the Analyses of Samples of the three kinds of fertilizers, which were analysed and carried out in the Brazilian Institute of Analysis.

### 8.3. The Operating System

The operating system of plantation allows to work a single person or to form groups or teams of work, of two, three, four, five, six or more users (22), with the product stocked and prepared for use in an adequate tanker, which will also serve to accommodate and package seedlings already prepared for plantation, as well as to accommodate other equipments and necessary accessories for the correct operation of the equipment, such as tips and other pieces of change on the occasion of eventual maintenance.

The equipment litigated by the requester permits, therefore and in function of what was described, the planting of seedlings using a means that permits the insertion of seedlings (M) of diverse types and concomitantly, to apply the necessary products (P) for the full development of the seedlings, such as, moisturizing products based on water, soil improvers, fertilizers, etc., from the driving of adequate pouring devices and of a device that permits the opening of a hole in the ground to place and to plant the seedlings (M).

### 9. CONCLUSION

It is verified that this Equipment for Seedlings Plantation with Simultaneous Application of Moisturizing Products Based on Water, Soil Improvers and/or Fertilizers and the Corresponding System of Planting Seedlings, is constituted in agreement to what was previously mentioned, by equipment (1), product (P) and operating system of plantation, filling an important existing gap in the market, deserving for what was shown and as consequence, the respective privilege.

1) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, characterized by being constituted by an equipment (1) applying device, a chemical composition with properties of being an improver of soil and absorbent of water and a operational system, in an individual or group way, of plantation of seedlings (S) of trees or other cultures such as soya, cane or others and finally the application of the product (P).

2) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, according to claim one, characterized because the equipment (1) is formed by a basic model and two constructive variations, and be constituted by a cylindrical main body, leaked and lengthened, with a conical end or tip (3) gifted of a movable part (4) articulated for the opening and passage of the seedlings (M) and of the product (P).

3) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, according to claim number 1, characterized because in the first constructive variation the equipment (1) is constituted by body (2), head (14), tip (3) with movable part (4), tubular end (5), means of outflow (6), gauntlets (10), levers (11) or devices of operation, articulated bars (12) of transmission.

4) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, according to claim 1, characterized because the body (2) is a tubular element of adequate diameter to allow the introduction and sliding of sheat dress containing seedlings (S), it has a head (14), the head (14) which corresponds to a ring fixed to the upper part of the body (2), it is provided with grooves, holes or openings to allow the placement of the devices of fixation also provided with gauntlets (10) and protected by gauntlets of rubber or another material and levers (11) as a means of operation, in the lower end the tip (3) is located, gifted of a movable part (4) being formed by an upper ring for its fixation to the body (2) by different devices of fixation.

5) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS” according to claim 1 characterized because in the second constructive variation were kept the same principles and elements used in the first variation being only replaced the articulated bars of transmission (12) by flexible elements such as ends (14).

6) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, characterized by having a Dose Device (14) of variable capacity, which will be able to be connected, optionally, to anyone of the models, Basic, First or Second Constructive Variation.

7) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, according to claim number 6, characterized because the Dose Device (14) is a container (15) of tubular shape or another with variable capacity to be determined according to the kind of soil or region, internally is provided with bezeled or chamfered walls to reduce friction and facilitate the evacuation of the Product (P), it has a measurer (17) of volume, breath (18) or valve of relief, valve of feeding (19), device of quick hitch (20) and simultaneous operational levers (21).

8) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, according to claim number 1 characterized because the product (P) is a combination of water and chemical fertilizer developed to be incorporated to the soil or substratum, it absorbs and keeps big quantities of water and of fertilizing elements, possessing the capacity of easily liberate the water and the nutrients for the plants in function of the cycles of absorption.

9) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, according to claim number 8, characterized because the product (P) is formed by a percentage of nitrogen (N) between 2.50 and 3.97%; a percentage of Phosphorus (P) between 1.46 and 1.79%; a percentage of Potassium (K) between 3.02 and 5.85%; a percentage of Calcium (Ca) between 10.48 and 14.43%; a percentage of Magnesium (Mg) between 5.33 and 7.00%; a quantity of Sodium (Na) between 364.65 and 449.55 ppm; a quantity of Copper (Cu) between 10.20 and 15.30 ppm; a percentage of Manganese (Mn) lower to 0.01%; a quantity of Iron (Fe) between 306.15 and 730.05 ppm; a quantity of Zinc (Zn) variable between 6.50 and 11.38 ppm; a quantity of Boron (B) lower to 0.01 ppm; a quantity of Cobalt (Co) equivalent to 13.15 ppm; a percentage of Sulfur (S) between 0.14 and 0.99%; a quantity of Aluminium (Al) between 300 and 1400 ppm and a quantity of Molybdenum (Mo) equivalent to 89.24 ppm, noticing that all these elements are contained, according to what was previously described, in relation to the variables quantities of the kind of the chosen product (P), presenting a Water Retention Capacity or WRC between 3347 and 7586.00 g/100 g and a Capacity of Cationic Change or CTC between 49.50 and 83.00 meq/100 g.

10) “EQUIPMENT FOR SEEDLINGS PLANTATION WITH SIMULTANEOUS APPLICATION OF MOISTURIZING PRODUCTS BASED ON WATER, SOIL IMPROVERS AND/OR FERTILIZERS AND THE CORRESPONDING SYSTEM OF PLANTING SEEDLINGS”, according to claim number 1, characterized because it is going to form groups or teams of work with variable quantities if users (22), with the product stocked and prepared to use in adequate tankers, which will also serve to accommodate and package of seedlings already prepared for plantation, as well as to accommodate other equipments and necessary accessories for the correct operation of the equipment, such as tips and other pieces of change on the occasion of eventual maintenance.
